(19) United States
(12) Patent Application Publication
(10) Pub. No.: US 2016/0221611 A1
(43) Pub. Date: Aug. 4, 2016

(54) FRONT BODY MODULE FOR A MOTOR VEHICLE

(71) Applicant: BASF SE, Ludwigshafen (DE)

(72) Inventors: Uwe WOLF, Starnberg (DE); Jan Kurt Walter SANDLER, Heidelberg (DE); Alex HORISBERGER, Ludwigshafen (DE); Tobias NACHTIGAELLER, Heidelberg (DE)

(73) Assignee: BASF SE, Ludwigshafen (DE)

(21) Appl. No.: 15/024,458

(22) PCT Filed: Sep. 22, 2014
(86) PCT No.: PCT/EP2014/070101

§ 371 Date: Mar. 24, 2016

(30) Foreign Application Priority Data
Sep. 24, 2013 (EP) 13185774.0

(51) Int. Cl. B62D 25/04; B62D 29/04; B60K 37/00; B62D 29/00

(52) U.S. Cl. CPC B62D 25/04; B62D 29/002; B62D 29/043; B60K 37/00

(57) ABSTRACT

The invention concerns a front body module (1) for a motor vehicle, comprising a windshield frame (3) with a left-hand A pillar (5), a right-hand A pillar (7) and a roof rail (9) connecting the A pillars (5, 7), an end wall (11) underneath the windshield frame (3), the end wall (11) providing the front delimitation of a passenger compartment of the motor vehicle, and an instrument panel support (13), the right-hand A pillar (7), the left-hand A pillar (5), the roof rail (9) connecting the A pillars (5, 7), the end wall (11) and the instrument panel support (13) being integrated in the front body module (1).

The invention concerns a front body module for a motor vehicle, comprising a windshield frame with a left-hand A pillar, a right-hand A pillar and a roof rail connecting the A pillars, an end wall underneath the windshield frame, the end wall providing the front delimitation of a passenger compartment of the motor vehicle, and an instrument panel support.

A vehicle body usually comprises a front module, in which for example the engine of the motor vehicle is accommodated, a central module, with the passenger seats, and a rear module, for example in the case of a limousine the trunk or in the case of a station wagon the loading area.

Vehicle bodies are usually produced from steel, the vehicle body having a supporting floor structure, which in the area of the central body module is produced as a floor panel. On the floor panel, the seats for the driver and front passenger are then later mounted, and optionally a rear bench seat. In the case of modern motor vehicles, the side modules of the motor vehicle, for example fenders, A, B and C pillars, are attached laterally to the supporting structure. The A, B and C pillars are connected to one another by cross members and bear the vehicle roof. Furthermore, there are usually roof rails between the A pillar and the B pillar and also between the B pillar and the C pillar. The individual components of the vehicle body are usually welded to one another and, to provide them with sufficient corrosion resistance, must be subsequently provided with a coating in a laborious process. Moreover, cavities must be sealed, in order that no water, and in particular corrosive salt, can get in.

In order to save energy for moving the motor vehicle, efforts are currently being made to reduce the weight of the vehicle. This is possible for example by using materials with lower density than steel, for example plastics. Particularly non-load-bearing components are currently being produced from plastics. A further disadvantage of the present structure of motor vehicle bodies is that great amounts of material are required to achieve sufficient stability, likewise leading to greater weight.

It is therefore an object of the present invention to provide a front body module that is configured to allow a lower weight to be achieved than in the case of conventional central body modules on the basis of material savings and the choice of materials, and which can be connected in an easy way to a central body module.

The object is achieved by a front body module for a motor vehicle, comprising a windshield frame with a left-hand A pillar, a right-hand A pillar and a roof rail connecting the A pillars, an end wall underneath the windshield frame, the end wall providing the front delimitation of a passenger compartment of the motor vehicle, and an instrument panel support, the right-hand A pillar, the left-hand A pillar, the roof rail connecting the A pillars, the end wall and the instrument panel support being integrated in the front body module.

The A pillars, the roof rail connecting the A pillars, the end wall and the instrument panel support may in this case be integrated in the front body module in one piece or as more than one part.

The integration of the A pillars, roof rail, end wall and instrument panel support achieves an additional stiffening of the front body module, so that additional material for reinforcing elements on the front module can be saved. Moreover, this allows the creation of a stable front body module, which can then be connected in an easy way to a central module. This allows the separate production of the front body module, central body module and rear body module. A modular structure of the vehicle body is made possible as a result, so that any desired front modules, central modules and rear modules can be combined with one another, as long as the dimensions at the connecting points of the front module to the central module and from the central module to the rear module coincide.

A further advantage is that, apart from the material saving, alternative materials can be used. Corresponding alternative materials are, for example, polymer materials. These allow a further weight reduction of the front module. Within the scope of the present invention, polymer materials comprise not only unreinforced polymers but also reinforced polymers and composite materials that comprise a polymer matrix.

Depending on the vehicle concept, the front body module may also comprise a mounting for a drive unit for the motor vehicle. Corresponding drive units are, for example, internal combustion engines or else a central electric motor. In the case of motor vehicles that are driven for example by wheel-hub motors or in which the drive module is positioned in the rear, the front body module may also comprise a luggage compartment or else, for example, mountings for batteries. For this purpose it is possible for example to provide on the front body module a floor panel and fenders and also a correspondingly movable cover, which is usually referred to as the engine hood. These may likewise be connected in one piece to the A pillars, the roof rail and the end wall. Alternatively, it is also possible to provide separate add-on parts here. If the floor panel, fenders and engine hood are provided as separate parts, the front body module represents the front termination of the passenger compartment of the motor vehicle. It is preferred, however, if the front body module comprises all of the load-bearing parts for the body front end. Non-load-bearing parts, for example fenders placed on corresponding supports or the engine hood, may then be correspondingly attached in a modular manner and also be exchangeably fitted, for example by corresponding mounting, for example by clipping, so that in this way an easy modification of the motor vehicle is possible.

Suitable rails may be provided for example as supports for the drive unit or trunk and for fastening fenders. These rails may be integrally connected to the front body module or alternatively releasably connected to it. An integral, positive connection, for example by adhesive bonding or welding, is preferred however. Alternatively, a nonpositive connection, for example by riveting or screwing, would also be possible.

In one embodiment of the invention, the A pillars and the roof rail are formed as hollow bodies, and a channel for ducting air and a cable harness are integrated in the A pillars and the roof rail. This duct for example may be inserted as a separate component into the A pillars and the roof rail, but it is preferred to produce the A pillars and the roof rail as hollow bodies, so that they can serve directly as a channel. The integration of the channel for ducting air and the cable harness into the A pillars and into the roof rail means that additional components can be avoided, and moreover as a result electrical components can for example be connected in an easy way by routing the cables in the A pillars and the roof rail. Any desired ventilation concept in which the ventilation outlets can be provided at any desired locations in the region of the A pillars and the roof rail can also be realized. This allows for example air to be fed into the passenger compartment without any drafts.

In order to supply the passenger compartment with fresh air, it is also preferred if feed channels for fresh air are formed in the end wall, underneath the windshield frame. The fresh air can then enter the passenger compartment through the feed channels via suitable ventilation outlets. If channels for feeding in fresh air are provided in the A pillars and the roof rail, the feeding channels for fresh air are preferably connected to the channels in the A pillars and the roof rail, so that the fresh air enters the channels in the A pillars and the roof rail via the feed channels.

If fresh air can enter the passenger compartment through the A pillars, it is possible for example to form in the A pillars openings through which the fresh air can flow out of the channel for ducting air into the passenger compartment. The openings may in this case be embodied in any configuration desired. For example, it is possible to provide a large number of small openings or else several larger openings. Any configuration desired is possible here. In particular, it is possible for example to configure the outlet openings for fresh air in the course of additive manufacturing. This also makes it possible for example to realize complex 3D grid structures, which make diffuse ventilation possible or by which different ventilation zones can be implemented in the passenger compartment.

In one embodiment of the front body module, a mirror support for a rearview mirror is formed on the roof rail. This mirror support is preferably likewise connected in one piece to the roof rail. The mirror support may additionally comprise a channel for ducting air and have openings through which fresh air can leave a channel for ducting air in the roof rail. With the openings for fresh air in the mirror support, it is possible for example to feed in warm air, with which rapid defrosting of the front window can be realized in winter. In addition, further adaptation of the ventilation zones in the motor vehicle is possible by means of the ventilation openings in the base of the mirror.

In a particularly preferred embodiment, the A pillars, the roof rail, the end wall and the instrument panel support are produced from a material comprising plastic. Suitable materials comprising plastic are, in particular, fiber-reinforced plastics, organosheets or sandwich structures.

Corresponding sandwich structures comprise, for example, two sheets of a fiber-reinforced plastic or a metal, between which a foam is incorporated.

If a fiber-reinforced plastic is used for producing the A pillars, roof rail, end wall and instrument panel support, a thermoplastic-based fiber-reinforced plastic is used particularly preferably as the matrix material. The fibers that are used may be short fibers, long fibers or continuous fibers. If the fibers used are in the form of continuous fibers, it is possible to use them as laid, knitted or woven structures or else in a random form. If the continuous fibers are used in the form of laid, woven or knitted structures, it is possible to position multiple layers of fibers one on top of the other. In the case of laid fiber structures, the fibers of the individual layers may be turned in relation to one another.

It is particularly preferred for the fibers to be used in the form of laid structures.

Suitable for example as the material for the fibers are glass fibers, carbon fibers, potassium titanate fibers, basalt fibers or aramid fibers. Suitable in particular as the polymer material for the matrix of such fiber-reinforced plastics are polyamides (PA), polyurethane (PU), polypropylene (PP) or polybutylene terephthalate (PBT). Polyamides or polyurethane are particularly preferred here.

An additional reinforcement can be achieved by a wire mesh being introduced into the individual components, in particular the A pillars, roof rail and the end wall. The wire of the wire mesh is in this case preferably produced from a metal. Suitable metals for this are, for example, steel, aluminum or magnesium. Steel is used with particular preference as the metal.

If the A pillars, the roof rail, the end wall and/or the instrument panel support are produced from a sandwich structure, in particular in the form of a two-shell structure with a foam introduced in between, or alternatively also completely from a metal, the metal is preferably selected from steel, aluminum or magnesium.

However, fiber-reinforced polymers are also preferred for the two-shell structure.

The foam that is introduced between the two shells of fiber-reinforced plastic or metal in the case of a two-shell structure, i.e. a sandwich structure, is preferably a polymer foam. Suitable polymer foams are, for example, closed-cell or open-cell foams on the basis of polyurethane (PU), polyether sulfone (PES), polyamide (PA), polybutylene terephthalate (PBT) or polyester.

In order to obtain a one-piece structure comprising the A pillars, roof rail, end wall and instrument panel support, they are preferably positively connected to one another. Particularly preferably, the A pillars, the roof rail, the end wall and the instrument panel support are welded to one another. Apart from welded connections, however, it is alternatively also possible to adhesively bond the individual parts to one another. Alternatively, they may also be nonpositively connected to one another, for example by riveting or screwing.

In a particularly preferred embodiment of the invention, the instrument panel support has a coating of an open-cell plastics material. Such a coating is available for example under the trade name Steron® from BASF SE. This involves a surface coating technology that can be applied for example to a PU skin. Such an open-cell structure allows capacitive switches and/or illuminated display elements to be positioned under the coating of the open-cell plastics material. This makes a completely closed instrument panel possible, without visible joins or separations being required. The position of switches under the coating of the open-cell plastics material can be realized for example by corresponding suitable illumination. If capacitive switches are used, it is also possible for them to be actuated by simply being touched. It is not necessary to provide visible elevations that have to be pressed.

In order to satisfy the haptic requirements for the passenger compartment, it is also possible to apply a padding of a suitable polymer foam, for example a polyurethane foam, particularly to the instrument panel support, and subsequently provide it with a suitable surface coating. For this purpose, it is also possible to produce the surface for example from an unexpanded flexible polymer material or else from an open-cell polymer, for example Steron®.

For the production of a vehicle as a whole, the front body module is then connected to a central module and a rear module. The front body module is configured here in such a way that the central body module can be positively connected to the front body module, for example by welding or adhesive bonding. A nonpositive connection of the front body module and the central body module, for example by screwing or riveting, would also be possible.

In the case of a positive connection of the front body module and the central body module, it is preferred in particular if they are adhesively bonded to one another.

Exemplary embodiments of the invention are represented in the figures and are explained in more detail in the description that follows.

In the figures:

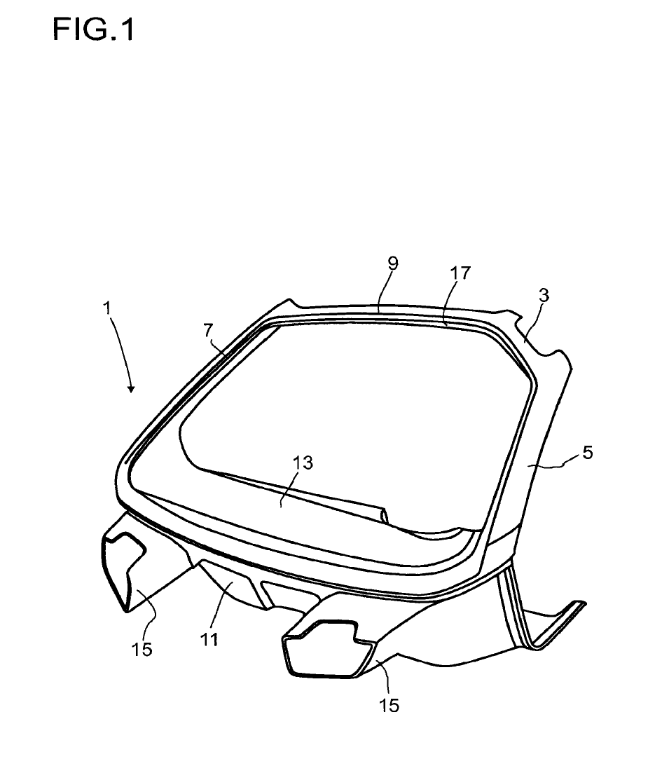

FIG. 1 shows a three-dimensional representation of a front body module,

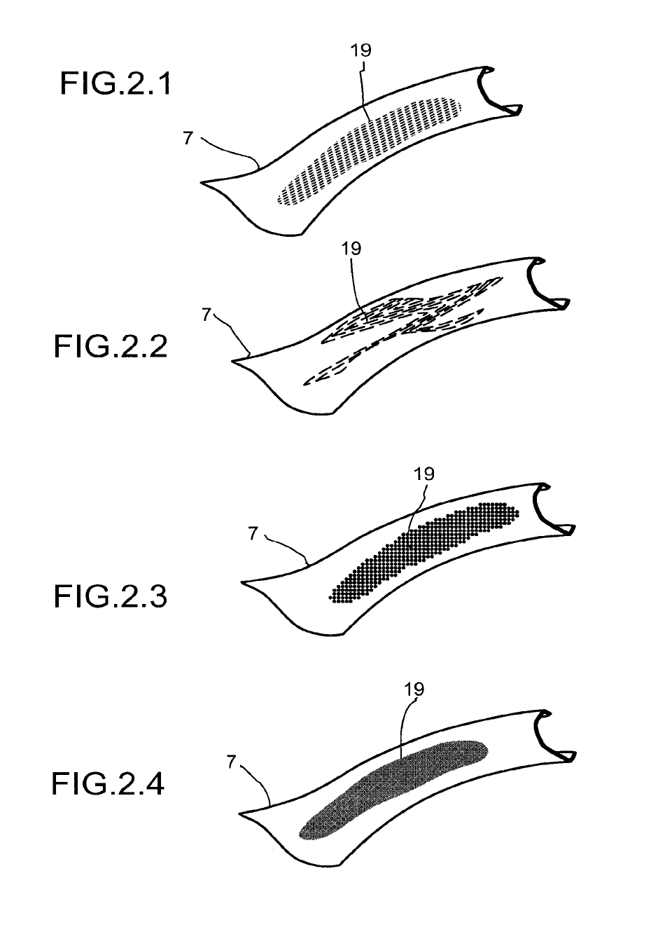

FIGS. 2.1-2.4 show various configurations of ventilation openings in A pillars,

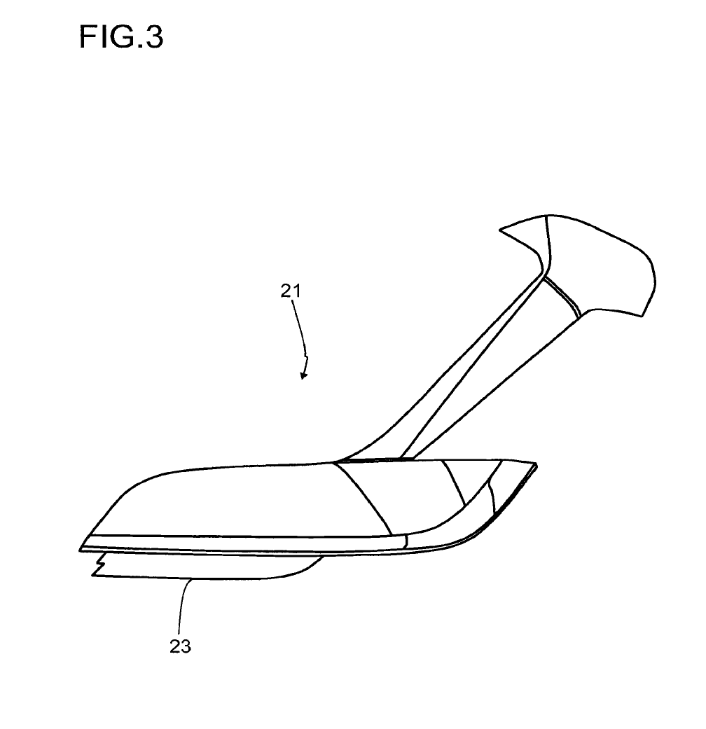

FIG. 3 shows a mirror base,

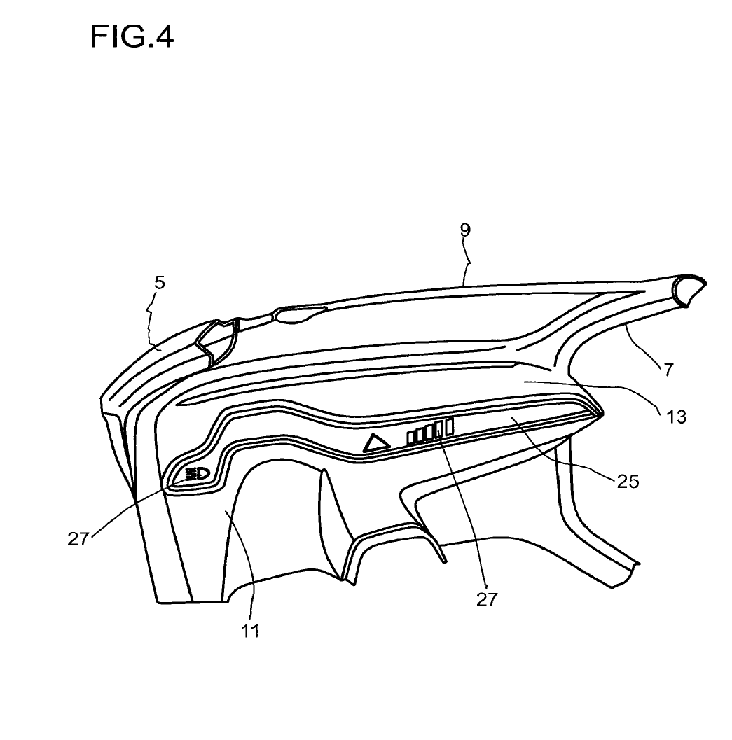

FIG. 4 shows a view of the front module from the passenger compartment.

FIG. 1 shows a three-dimensional representation of a front body module formed according to the invention.

A front body module 1 comprises a windshield frame 3 with a left-hand A pillar 5 and a right-hand A pillar 7 and also a roof rail 9 connecting the A pillars 5, 7. It also comprises an end wall 11, underneath the windshield frame 3, and an instrument panel support 13 that is only schematically represented in FIG. 1.

The front body module is also preferably configured in such a way that it can be connected to a correspondingly formed central body module. The connection of the front body module 1 to the central body module preferably takes place by welding or adhesive bonding. In addition or alternatively, it is also possible to screw or rivet the front body module 1 and the central body module.

A material comprising plastic, for example—as described above—a fiber-reinforced plastic, an organosheet or a sandwich structure, is preferably used as the material for the front body module 1.

It is also advantageous for configuring the front area of the motor vehicle if the support 15 is formed on the front body module in the region of the end wall 11. Front fenders can be attached for example to the cross members 15. Moreover, the cross members 15 can be used for configuring the front area of the vehicle, for example for modeling a space for a drive unit or alternatively also for receiving articles to be transported.

It is also advantageous if the cross members 15 are configured as hollow bodies, as represented in FIG. 1. In this case it is possible that the cross members may serve at the same time as an opening for feeding in fresh air. It is also preferred to configure the A pillars 5, 7 and the roof rail 9 as hollow bodies, these then being able to take the form of a channel through which the fresh air flows and can enter the passenger compartment of the motor vehicle via suitable ventilation openings. In addition, the electrical lines that are required for the operation and control of the motor vehicle may also be laid in the A pillars 5, 7 and the roof rail 9 formed as hollow bodies.

In the embodiment represented in FIG. 1, also formed on the windshield frame 3 is a recess 17, which is configured in such a way that it can receive the windshield (not represented here), the windshield usually being adhesively bonded in the recess 17. The adhesive bonding of the windshield in the windshield frame 3 has the effect of additionally reinforcing the front body module 1.

Various embodiments of ventilation openings in the A pillars are represented in FIGS. 2.1 to 2.4. The representation in FIGS. 2.1 to 2.4 is based in each case on the right-hand A pillar 7, by way of example. The left-hand A pillar 5 is then preferably configured mirror-symmetrically in relation to the right-hand A pillar 7 shown here.

In the embodiments represented here, ventilation openings 19 of various configurations are formed in the A pillars. Any desired forms and configurations of the ventilation openings 19 are possible here. For example, they may comprise holes of various sizes, with which various structures and configurations can be presented. The openings may also be chosen small enough to produce a porous surface and for the ventilation openings 19 to be virtually imperceptible. Apart from holes, it is also possible to configure the ventilation openings 19 in the form of slits and to arrange the slits in any desired arrangements in relation to one another. A combination of slits and circular holes is also possible. The slits may in this case also describe curves or angles. This allows a varied configuration of the ventilation openings 19. A further advantage of the free configuration of the ventilation openings 19 in the A pillars is that it is also made possible as a result for the passenger compartment to be ventilated substantially without any drafts. It is also possible to form different ventilation zones, in that for example the size or number of the ventilation openings over the length of the A pillars 5, 7 is varied.

The form of the ventilation openings 19 is preferably realized by additive manufacturing, also referred to as “rapid prototyping”. In additive manufacturing, a component is built up by material being applied layer by layer. Corresponding methods by which this can be realized are, for example, 3D printing, stereolithography or laser sintering.

Additive manufacturing allows complex three-dimensional structures to be formed, allowing diffuse ventilation.

Apart from the ventilation openings in the A pillars 5, 7, as represented in FIGS. 2.1 to 2.4, it is of course also possible to provide corresponding ventilation openings in the roof rail 9 or else in the instrument panel support 13. The arrangement of the ventilation openings 19 at any desired position in the front body module 1 likewise allows the implementation of various ventilation concepts, and in particular also diffuse ventilation, and consequently air to be fed into the passenger compartment without any drafts.

A mirror base 21 is preferably attached to the roof rail 9 of the front body module 1. Such a mirror base is represented by way of example in FIG. 3.

When forming the front body module from a material comprising plastic, it is likewise possible to embody the mirror base 21 in any configuration desired. It is also advantageous if the mirror base 21 is configured as a hollow body. It can then be connected to a roof rail 9 of a likewise hollow configuration, so that the roof rail 9 and the mirror base 21 likewise serve for ventilation. In this case it is possible for example, as represented in FIG. 3, to integrate additional air vents 23 in the mirror base. In the embodiment represented here, the air vents 23 are directed downward, and can thus serve for example for rapid defrosting of the front window or, if the front window is misted up, for ventilating the front window in order quickly to provide a clear view to the front.

As described above for the ventilation openings 19 in the A pillars 5, 7, the air vents 23 at the mirror base 21 are likewise preferably configured by rapid prototyping, so that the openings of the air vent 23 can be configured in such a way as to be individually adapted to the form of the vehicle. Apart from being aligned in such a way that flow is directed onto the front window in order to achieve more rapid clearing of a misted-up or frosted window, it is of course also possible to direct the openings of the air vent 23 into the passenger compartment in such a way that they can be used for additional ventilation of the passenger compartment.

In FIG. 4, a front body module is presented for example in a view from the passenger compartment of the vehicle.

In this case, an instrument panel 25 has been inserted into the instrument panel support 13. The instrument panel 25 is preferably coated with an open-cell plastics material. Such an open-cell plastics material on the one hand has a pleasant feel, on the other hand it is possible for example to position display elements 27 or else switches underneath the coating of the open-cell plastics material, the display elements appearing through the open-cell plastics material. This allows a uniform, smooth surface, and no visible joins or separations are required. If switches are accommodated underneath the coating of the open-cell plastics material, they are preferably capacitive, i.e. there are no visible switches, but instead the switches are actuated by simply being touched.

### LIST OF DESIGNATIONS

1 front body module
3 windshield frame
5 left-hand A pillar
7 right-hand A pillar
9 roof rail
11 end wall
13 instrument panel support
15 cross member
17 recesses
19 ventilation opening
21 mirror base
23 air vents
25 instrument panel
27 display elements

1-12. (canceled)

13. A front body module for a motor vehicle, comprising
a windshield frame with a left-hand A pillar, a right-hand A pillar and a roof rail connecting the A pillars,
an end wall underneath the windshield frame, the end wall providing the front delimitation of a passenger compartment of the motor vehicle, and
an instrument panel support,
the right-hand A pillar, the left-hand A pillar, the roof rail connecting the A pillars, the end wall and the instrument panel support being integrated in the front body module,
wherein the A pillars and the roof rail are formed as hollow bodies and a channel for ducting air and a cable harness are integrated in the A pillars and the roof rail.

14. The front body module according to claim 13, wherein feed channels for fresh air are formed in the end wall, underneath the windshield frame.

15. The front body module according to claim 13, wherein openings through which fresh air can flow out of the channel for ducting air into the passenger compartment are formed in the A pillars.

16. The front body module according to claim 13, wherein the A pillars, the roof rail, the end wall and the instrument panel support are produced from a material comprising plastic.

17. The front body module according to claim 16, wherein the material comprising plastic is a fiber-reinforced plastic, an organometallic sheet or a sandwich structure.

18. The front body module according to claim 17, wherein the sandwich structure is comprised of an upper and a lower sheet and also a polymer foam received between the sheets.

19. The front body module according to claim 18, wherein the upper sheet and the lower sheet is in each case an organosheet.

20. The front body module according to claim 13, wherein a mirror base for a rearview mirror is formed on the roof rail.

21. The front body module according to claim 20, wherein the mirror base comprises a channel for ducting air and has openings, through which fresh air can leave the channel for ducting air.

22. The front body module according to claim 13, wherein the instrument panel support has a coating of an open-cell plastics material.

23. The front body module according to claim 22, wherein capacitive switches and/or illuminated display elements are positioned underneath the coating of the open-cell plastics material.

24. The front body module according to claim 13, wherein the A pillars, the roof rail connecting the A pillars, the end wall and the instrument panel support are integrated in the front body module in one piece.

25. The front body module according to claim 15, wherein the openings are chosen small enough to produce a porous surface and for ventilation openings to be virtually imperceptible.

26. The front body module according to claim 23, wherein the capacitive switches and/or illuminated display elements are positioned under the coating in such a way that a uniform, smooth surface without visible joins or separations is present.
